(19) United States
(12) Patent Application Publication
(10) Pub. No.: US 2023/0403769 A1
(43) Pub. Date: Dec. 14, 2023

(54) TWO-STEP DOOR OPENING LOCK

(71) Applicant: WHIRLPOOL CORPORATION, Benton Harbor, MI (US)

(72) Inventors: Yecai CHEN, Shenzhen (CN); Hua GUO, Shenzhen (CN); Benjamin T. KUNST, Benton Harbor, MI (US); Charles Tat Kan LAI, Choi Hung (HK); Cui Qing LIN, Fishan (CN); Bo WU, Shenzhen (CN); Tingting YU, Shenzhen (CN)

(21) Appl. No.: 18/316,825

(22) Filed: May 12, 2023

(30) Foreign Application Priority Data
Jun. 10, 2022 (CN) 2022214479257

(51) Int. Cl. H05B 6/64; H05B 6/68; E05B 47/00

(52) U.S. Cl. CPC H05B 6/6417; H05B 6/687; E05B 47/0002; E05B 2047/0054; E05Y 2900/308

(57) ABSTRACT

A two-step door opening mechanism for an oven is provided. A mechanical button and an electronic button are provided, the oven defining an oven cavity openable and closable by an oven door. A controller is provided. A digital valve, comprising a shaft configured to slide laterally between a first, unlocked position in which the shaft allows inward movement of the mechanical button and a second, locked position in which the shaft blocks the inward movement of the mechanical button. The electronic button, once actuated, is operable to cause the controller to direct the digital valve to move the shaft from the second, locked position into the first, unlocked position to unlock the mechanical button, and the mechanical button, once actuated, is operable to open the door when the shaft is in the first, unlocked position.

### CROSS-REFERENCE TO RELATED APPLICATIONS

This application claims the benefit of Chinese Application No. 2022214479257 filed Jun. 10, 2022, the disclosure of which is hereby incorporated in its entirety by reference herein.

### TECHNICAL FIELD

Aspects of the disclosure relate to appliances, and more particularly, to ovens that implement a two-step locking mechanism for selective access to the oven cavity.

### BACKGROUND

Ovens are kitchen appliances that are used to cook food. A door may provide access to the oven cavity when open and seal the oven cavity for cooking when closed. A door opener mechanism may be provided to allow the user to open the door. In many examples, this mechanism includes a single button that, when pressed into the face of the oven, pushes upon an internal mechanism to unlatch and push the door outward towards the user.

### SUMMARY

In one or more embodiments, a two-step door opening mechanism for an oven is provided. A mechanical button and an electronic button are provided, the oven defining an oven cavity openable and closable by an oven door. A controller is provided. A solenoid, comprising a shaft configured to slide laterally between a first, unlocked position in which the shaft allows opening of the oven door and a second, locked position in which the shaft blocks the opening of the oven door. The electronic button, once actuated, is operable to cause the controller to direct the solenoid to move the shaft from the second, locked position into the first, unlocked position, and the mechanical button, once actuated, is operable to open the door when the shaft is in the first, unlocked position.

In one or more embodiments, the controller is configured to direct the solenoid to move the shaft into the second, locked position responsive to initiation or completion of a cooking cycle by the oven.

In one or more embodiments, the controller is configured to direct the solenoid to move the shaft from the second, locked position into the first, unlocked position to unlock the mechanical button responsive to elapsing of an unlock timeout started responsive to initiation or completion of a cooking cycle by the oven.

In one or more embodiments, the electronic button is located on a control panel of the oven, the control panel being configured to receive user input for selection of cooking cycles.

In one or more embodiments, the controller is configured to monitor a control panel of the oven for entry of a sequence, such that responsive to entry of the sequence, the controller disables operation of the solenoid to cause the solenoid to remain in the first, unlocked position. In one or more embodiments, responsive to entry of the sequence when the solenoid is disabled, the controller reenables operation of the solenoid to cause the solenoid to remain in the first, unlocked position.

In one or more embodiments, the solenoid is mounted above the mechanical button, such that the shaft is lowered in the second, locked position to block inward movement of the mechanical button, and is raised in the first, unlocked position to allow the inward movement of the mechanical button.

In one or more embodiments, the oven includes a through hole to receive an instruction configured to move the shaft to allow manual unlocking of the solenoid.

In one or more embodiments, the shaft in the first, unlocked position allows inward movement of the mechanical button and the shaft in the second, locked position blocks the inward movement of the mechanical button.

In one or more embodiments, the controller is configured to apply power to the solenoid to place the shaft in the second, locked position, and to remove power from the solenoid to place the shaft in the first, unlocked position.

In one or more embodiments, a system for operation of a two-step door opening mechanism for an oven is provided, the two-step door opening mechanism having a mechanical button and an electronic button, the oven defining an oven cavity openable and closable by an oven door. A controller is configured to responsive to actuation of the electronic button, direct a solenoid to move a shaft from a second, locked position into a first, unlocked position to unlock the mechanical button; and responsive to actuation of the mechanical button when unlocked, open a door to an oven cavity.

In one or more embodiments, the controller is further configured to direct the solenoid to move the shaft into the second, locked position responsive to initiation or completion of a cooking cycle by the oven.

In one or more embodiments, the controller is further configured to direct the solenoid to move the shaft from the second, locked position into the first, unlocked position responsive to elapsing of an unlock timeout started responsive to initiation or completion of a cooking cycle by the oven.

In one or more embodiments, the controller is further configured to: monitor a control panel of the oven for entry of a sequence; responsive to the entry of the sequence when the solenoid is enabled, disable operation of the solenoid to cause the solenoid to remain in the first, unlocked position; and responsive to the entry of the sequence when the solenoid is disabled, reenabling operation of the solenoid to cause the solenoid to remain in the first, unlocked position.

In one or more embodiments, the controller is further configured to: apply power to the solenoid to place the shaft in the second, locked position, and remove power from the solenoid to place the shaft in the first, unlocked position.

In one or more embodiments, a method for operation of a two-step door opening mechanism for an oven is provided, the two-step door opening mechanism having a mechanical button and an electronic button, the oven defining an oven cavity openable and closable by an oven door. Responsive to actuation of the electronic button, a solenoid is directed to move a shaft from a second, locked position into a first, unlocked position to unlock the mechanical button. Responsive to actuation of the mechanical button when unlocked, a door to an oven cavity is opened.

In one or more embodiments, the method further includes directing the solenoid to move the shaft into the second, locked position responsive to initiation or completion of a cooking cycle by the oven.

In one or more embodiments, the method further includes directing the solenoid to move the shaft from the second, locked position into the first, unlocked position responsive to elapsing of an unlock timeout started responsive to initiation or completion of a cooking cycle by the oven.

In one or more embodiments, the method further includes monitoring a control panel of the oven for entry of a sequence; responsive to the entry of the sequence, disabling operation of the solenoid to cause the solenoid to remain in the first, unlocked position; and responsive to the entry of the sequence when the solenoid is disabled, reenabling operation of the solenoid to cause the solenoid to remain in the first, unlocked position.

In one or more embodiments, the method further includes applying power to the solenoid to place the shaft in the second, locked position, and removing power from the solenoid to place the shaft in the first, unlocked position.

### BRIEF DESCRIPTION OF THE DRAWINGS

FIG. 1 illustrates an example front view of an oven having a lockable door opening mechanism;

FIG. 2 illustrates an example rear view of the two-step door opening mechanism;

FIG. 3 illustrates an example controller configured to operate the components of the oven;

FIG. 4 illustrates an example of the solenoid in the first, unlocked state;

FIG. 5 illustrates an example of the solenoid in the second, locked state;

FIG. 6 illustrates an example of performance of the first step of the two-step door opening mechanism;

FIG. 7 illustrates an example of performance of the second step of the two-step door opening mechanism;

FIG. 8 illustrates an example of entry of a sequence into the control panel to toggle operation of the two-step door opening mechanism;

FIG. 9 illustrates an example process for utilizing the two-step door opening mechanism to perform a two-step locking of the door of the oven; and

FIG. 10 illustrates an example process for toggling activation of the two-step locking of the door of the oven.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A single step door opener mechanism may be easy for a user to operate. Such a mechanism may include a mechanical door button that, when pressed, causes the mechanical door button to engage a door opening mechanism to push the oven door open. However, such a mechanism may lack child resistance. That is, a child may open the oven after a cooking cycle and may hurt himself or herself on the heated food items.

A solenoid may be positioned to cause a shaft of the solenoid to physically block operation of the oven, unless a current is applied to the solenoid to move the shaft and allow the movement of the door mechanism. However, such an approach renders the door of the oven inoperable in many conditions, such as when the oven is being shipped or is unplugged.

Aspects of the disclosure describe a two-step mechanism to allow for the operation of the oven door. Using the two-step mechanism, responsive to a cooking cycle (e.g., initiation of the cycle, completion of the cycle, etc.), a solenoid may be engaged to physically block opening of a door to the oven cavity. This accordingly prevents a child from using the mechanical door button to open the door when there are likely to be hot contents within the oven cavity. An electronic door button may be provided in the control panel of the oven. Responsive to a user pressing the electronic door button, the solenoid may be disengaged to again allow use of a mechanical door button of the oven to open the physical door. Thus, child resistance may be offered by requiring two distinct actions to be performed before opening the oven door.

Ease of actuation may be maintained by both the mechanical door button and the electronic door button being placed in a convenient location, including but not limited to the front face of the oven. Yet further, the operation of the two-step mode may be enabled or disabled by a user by entering a predefined sequence into the control panels. The solenoid may also optionally be disengaged responsive to expiration of a timer after cooking is complete and/or the food has cooled. Thus, the instant disclosure provides the advantage of having child lock capabilities, as well as providing both buttons as being within easy reach for an adult user on the front face of the oven.

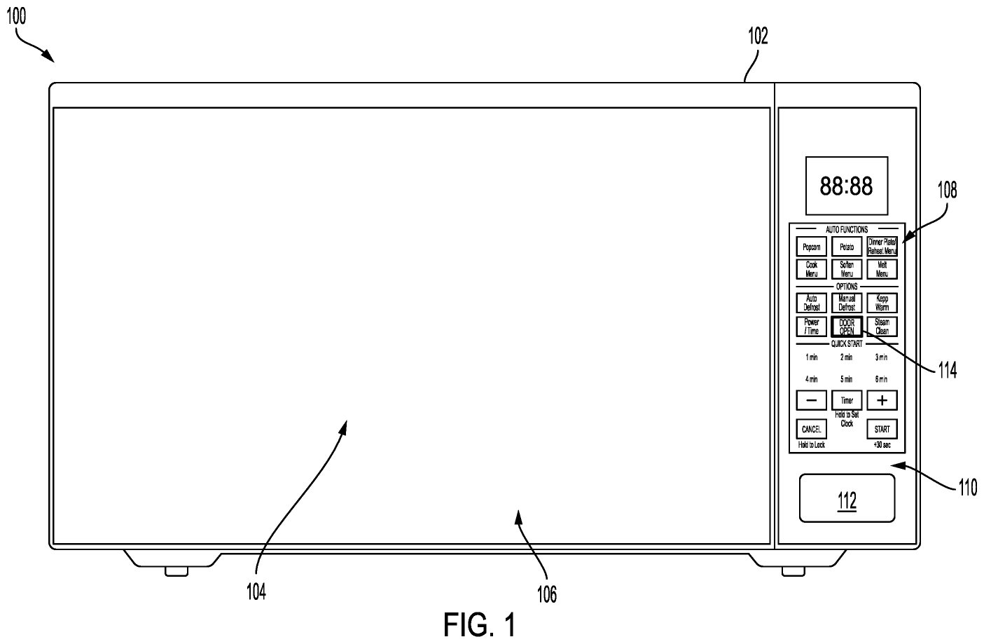

FIG. 1 illustrates an example front view of an oven 100 having a two-step door opening mechanism 110. The oven 100 may be of various types, such as a conventional oven, a microwave oven, or a combination microwave oven. The oven 100 generally has a housing 102 that defines an oven cavity 104. The oven cavity 104 generally has a back wall, a top wall, a bottom wall, and a pair of opposing side walls. The oven 100 also includes a door 106 to the oven cavity 104. As explained in detail herein, the two-step door opening mechanism 110 may be used to allow the door 106 to the oven cavity 104 to be secured closed and be opened based on two-step operator input.

A control panel 108 may be provided on the front face of the oven 100. The control panel 108 may include controls that, when operated by a user, allow for the user to select one or more modes of operation for the oven 100. The control panel 108 may include knobs, buttons, or other control for controlling the operation of the oven 100. The control panel 108 may accordingly allow a user to select different levels of cooking. The control panel 108 may also include one or more display elements such as light emitting diodes (LEDs).

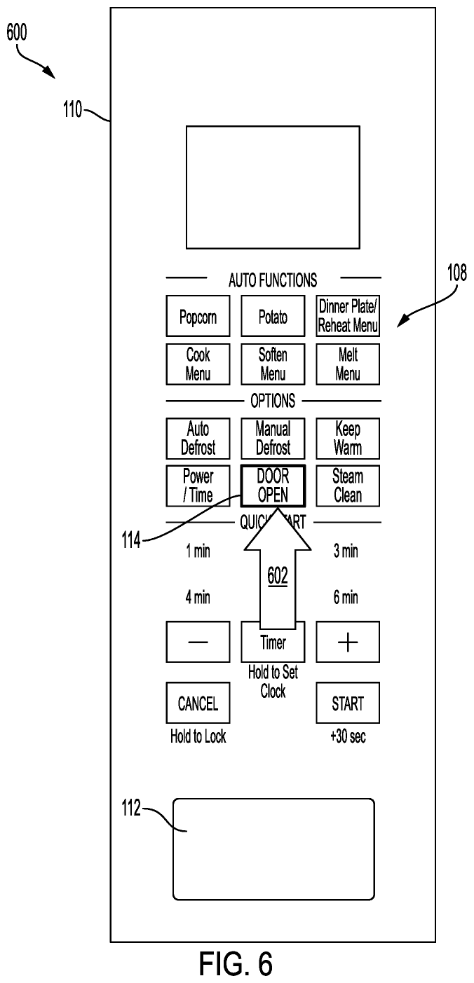

The two-step door opening mechanism 110 may be configured to allow a user to perform two distinct actions to open the door 106 to the oven cavity 104. In an example, the two-step door opening mechanism 110 may include a mechanical door button 112 and an electronic door button 114. The mechanical door button 112 and the electronic door button 114 as shown are both located on the front face of the housing 102, however other locations are possible. In many examples, this may include the electronic door button 114 being located as a control within the control panel 108 on the front face of the oven 100. (Further aspects of the electronic door button 114 are shown in detail in user interface FIGS. 6-8.) In some single button designs, the front face of the oven 100 may include a single rectangular button that, when actuated by a user, allows the user to open the door 106. In many two-step door opening mechanism 110, the mechanical door button 112 may also define the same rectangular area as is typically used in such single button designs.

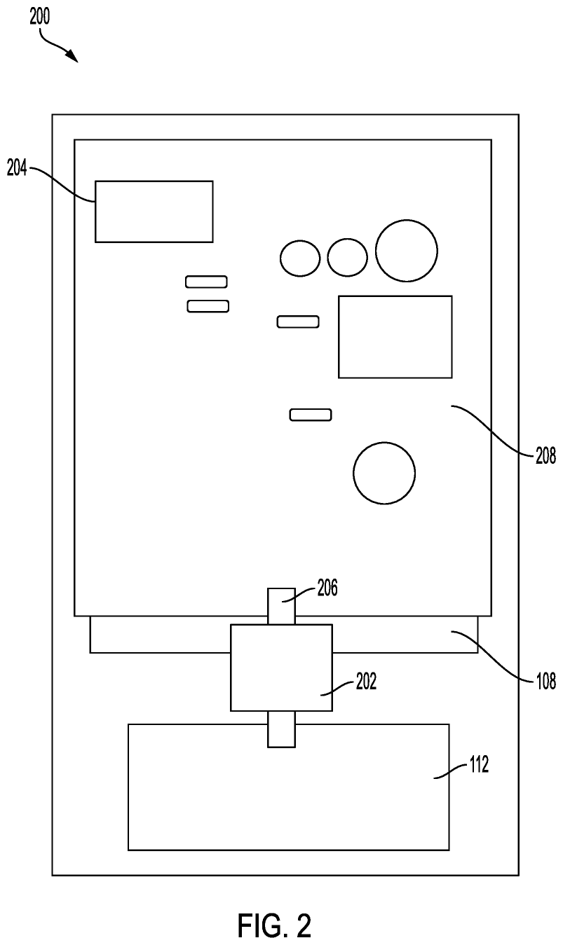

FIG. 2 illustrates an example rear view of the two-step door opening mechanism 110. As shown, the back of the circuitry of the control panel 108 is shown, which in this example includes a base electronics board 208 supporting the button elements of the control panel 108. The reverse side of the mechanical door button 112 may also be seen.

A solenoid 202, or digital valve, may be mounted to the back of the control panel 108, which may be controlled by a relay control 204 mounted to the electronics board 208. In an example, the solenoid 202 may be a 12-volt direct current (DC) electromagnet solenoid. The solenoid 202 may include a stationary coil of wire around a shaft 206 element. When the coil is powered, the coil creates a magnetic field to laterally move a shaft 206 element. The solenoid 202 may be controllable via the relay control 204 between a first, unlocked state in which the shaft 206 allows operation of the oven door 106 and a second, locked state in which the shaft 206 blocks or otherwise mechanically prevents operation of the oven door 106. In a more specific example, this may include in the first, unlocked state the shaft 206 allowing the mechanical door button 112 to be movable inwards and in the second, locked state the shaft 206 preventing the mechanical door button 112 from being moved inwards.

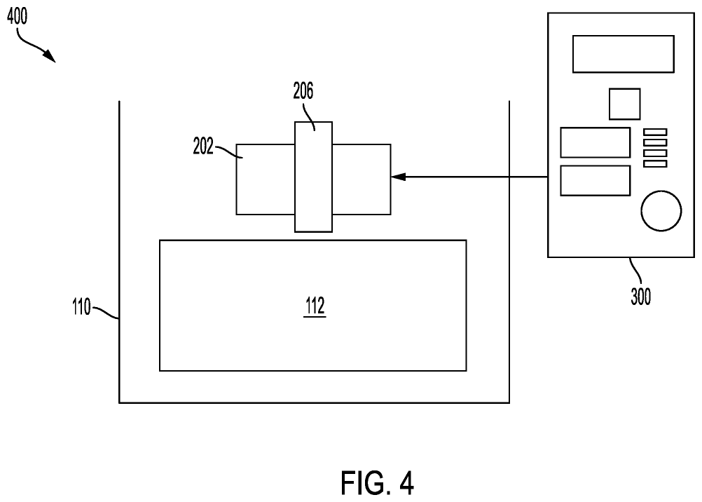

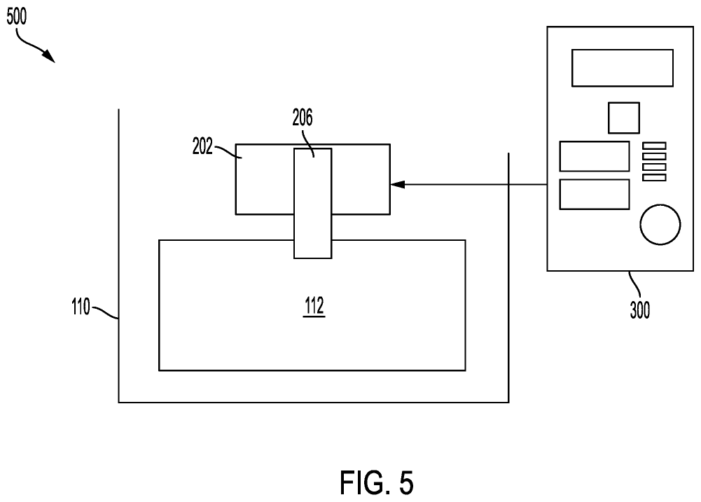

In the illustrated example, the solenoid 202 is mounted vertically above the mechanical door button 112. In such an orientation, in the first, unlocked state the shaft 206 is raised upwards away from the mechanical door button 112 to allow inward movement of the mechanical door button 112. (This is more clearly illustrated in FIG. 4, discussed in detail below). Similarly, in the second, locked state the shaft 206 extends downward behind the mechanical door button 112 to block inward movement of the mechanical door button 112. (This is more clearly illustrated in FIG. 5, also discussed in detail below).

It should be noted that this orientation is merely an example, and other mountings and/or relative locations of the solenoid 202 and the mechanical door button 112 may be used. For instance, the solenoid 202 may be located below or to the side of the mechanical door button 112, provided that the shaft 206 may be moveable between the second, locked state in which the shaft 206 blocks operation of the mechanical door button 112 and the first, unlocked state in which the shaft 206 allows operation of the mechanical door button 112. Or, the solenoid 202 may be located in another position apart from the mechanical door button 112 to otherwise block the movement of the door opening mechanism in a mechanical location other than that of the mechanical door button 112 itself.

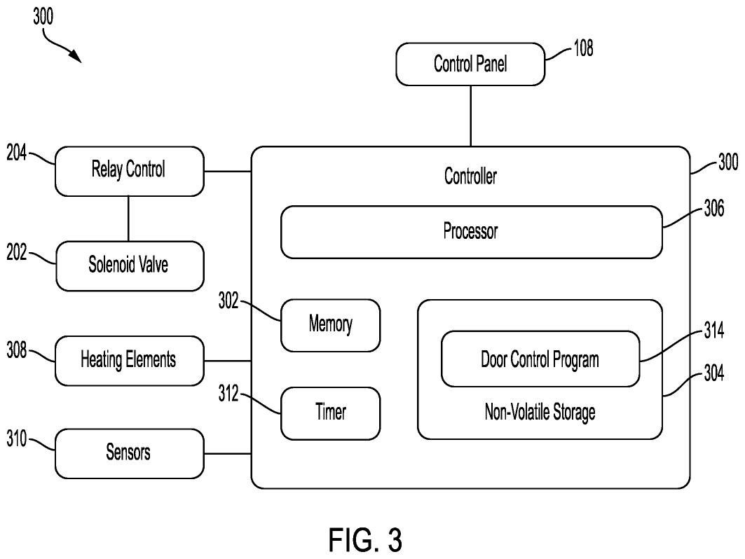

FIG. 3 illustrates an example controller 300 configured to operate the components of the oven 100. In an example, the controller 300 may operate the oven 100 to perform cooking cycles to prepare food items placed in the oven cavity 104. The controller 300 may include a memory 302, a non-volatile storage 304, a processor 306, and a timer 312. The non-volatile storage 304 may store operations for a two-step door program 314 configured to allow the oven 100 to operate the relay control 204 to control the operation of the solenoid 202 between the first, unlocked state and the second, locked state.

The memory 302 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 304 may include one or more persistent data storage devices such as a hard drive, optical drive, tape drive, non-volatile solid-state device, cloud storage or any other device capable of persistently storing information.

The processor 306 may include one or more microprocessors, micro-controllers, digital signal processors, microcomputers, central processing units (CPU), graphical processing units (GPU), tensor processing units (TPU), field programmable gate arrays, programmable logic devices, state machines, logic circuits, analog circuits, digital circuits, or any other devices that manipulate signals (analog or digital) based on computer-executable instructions residing in memory 302. The processor 306 also makes use of a timer 312 to perform timing and counting operations, allowing the processor 306 to carry on with other processing while the timer 312 measures delay.

The processor 306 may be configured to read into memory 302 and execute computer-executable instructions residing in the non-volatile storage 304, such as those of the two-step door program 314. Upon execution by the processor 306, the computer-executable instructions may cause the oven 100 to implement one or more of the algorithms and/or methodologies disclosed herein.

The controller 300 may be electrically connected to signaling interfaces of other components of the oven 100, thereby allowing the processor 306 of the controller 300 to manipulate the functions of the oven 100. In an example, the controller 300 may be a component of the electronics board 208. The controller 300 may be configured to receive user input from the controls of the control panel 108, such as requests to initiate a cooking or cleaning cycle.

To perform a cooking cycle, food is placed in the oven cavity 104 and the door 106 is closed. Responsive to selection of a cooking cycle from the control panel 108, the controller 300 may activate heating elements 308 of the oven 100, such as a magnetron and mode stirrer, to provide microwave energy into the oven cavity 104 to further cook the food items. In another example, the controller 300 may additionally or alternately activate resistive or other types of heating elements 308 to cook the food items. In yet another example, the controller 300 may additionally or alternately activate fans configured to provide convection and/or heat disposal airflows with respect to the oven cavity 104.

The controller 300 may also be configured to receive sensor input from the one or more sensors 310 may be arranged within the oven cavity 104 to allow for measurement of the temperature or other operational parameters at different locations within the oven cavity 104. In some examples, the sensors 310 may allow the controller 300 to identify when the cooking cycle is complete. In other examples, the timer 312 may be additionally or alternately utilized to determine when the cooking cycle is complete. This may be accomplished, for example, due to the expiration of a predefined number of seconds or minutes of operation of the heating elements 308.

Once the food is heated, the controller 300 may deactivate the heating elements 308. The door 106 may be reopened and the food removed. The oven 100 may also include a door switch (not shown) that detects whether the door 106 is open or closed, such that the controller 300 may automatically deactivate the heating elements 308 should the door switch indicate to the controller 300 that the door 106 was opened during a cooking cycle.

The two-step door program 314 may be configured to transition the solenoid 202 between the second, locked state in which the shaft 206 blocks operation of the mechanical door button 112 and the first, unlocked state in which the shaft 206 allows operation of the mechanical door button 112. This may be accomplished, for example, by the two-step door program 314 directing the controller 300 to power or remove power from the relay control 204.

In one example, the solenoid 202 may be biased into the first, unlocked position, such as using a spring or other biasing member. In such an example, the controller 300 may power the solenoid 202 via the relay control 204 to move into the second, locked state, where the solenoid 202 may automatically revert to the first, unlocked state when power is removed from the solenoid 202 via the relay control 204. This example has the advantage that the door 106 may be openable if the oven 100 is unpowered.

In another example, the solenoid 202 may fall downward into the second, locked position due to gravity, and may be moved into the first, unlocked position via powering of the solenoid 202 via the relay control 204. In yet a further example, the solenoid 202 may, due to friction or other mechanism, remain in the last controlled state into which the solenoid 202 is placed. In such an example, the relay control 204 may momentarily power the solenoid 202 in a first electrical direction to move the shaft 206 into the first, unlocked position, and may momentarily power the solenoid 202 in a second, opposite electrical direction to move the shaft 206 into the second, locked position. (In some examples, while not shown, a through hole may be located on the housing 102 to allow a user to manually push the solenoid 202 into the unlocked position, for example, if the solenoid 202 gets stuck in the locked position.)

Referring more specifically to FIG. 4, the figure illustrates an example 400 of the solenoid 202 in the first, unlocked state. This state may be an idle or standby state of the oven 100. The oven 100 may default to this state if no cooking has been performed. The controller 300 may operate the solenoid 202 to return to the idle state if no cooking has been performed for a predefined period of time, such as 5 minutes, 20 minutes, 30 minutes, etc. This determination may be made by the controller 300 using the timer 312, in an example. In yet another example, when the door 106 is locked, a user may press the electronic door button 114, which may cause the controller 300 to move the solenoid 202 into the first, unlocked state.

FIG. 5 illustrates an example 500 of the solenoid 202 in the second, locked state. For instance, responsive to initiation of a cooking cycle (or, in other examples, to completion of the cooking cycle), the controller 300 may operate the solenoid 202 to lock the mechanical door button 112 to prevent the oven cavity 104 from being accessed if the electronic door button 114 has not yet been pressed. This may accordingly prevent a child from accessing hot food items in the oven cavity 104.

FIG. 6 illustrates an example 600 of performance of the first step of the two-step door opening mechanism 110. As shown at operation 602, a user of the oven 100 may press the electronic door button 114 to perform the first step in opening the door 106 to the oven cavity 104. Responsive to receipt of the user press of the electronic door button 114, the controller 300 may instruct the relay control 204 to transition the shaft 206 of the solenoid 202 to the first, unlocked state. For instance, this may be accomplished by removing power from the solenoid 202 via the relay control 204.

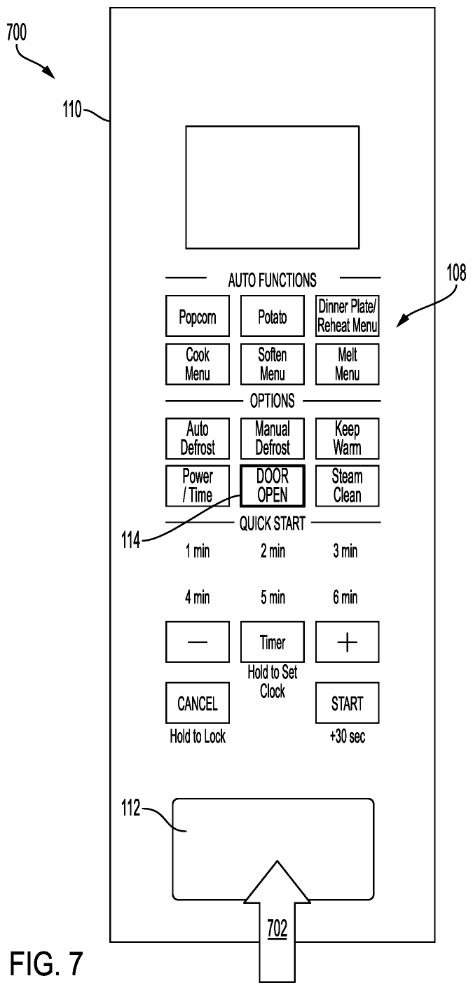

FIG. 7 illustrates an example 700 of performance of the second step of the two-step door opening mechanism 110. As shown at operation 702, after the user of the oven 100 has performed the operation 602, the user may press the mechanical door button 112 to perform the second step in opening the door 106 to the oven cavity 104. As the shaft 206 has been moved to unblock the motion of the mechanical door button 112, the door 106 may now be opened.

It should be noted that in some cases, the user may desire to turn off the operation of the two-step door opening mechanism 110. For instance, the oven 100 may be placed in a location where there are no potential child users. In such a situation, it may be desirable for the oven 100 to be configured to cause the controller 300 to keep the solenoid 202 in the first, unlocked position. Thus, when the two-step door opening mechanism 110 is disabled, pressing the mechanical door button 112 alone may be sufficient to cause the door 106 to the oven cavity 104 to be opened.

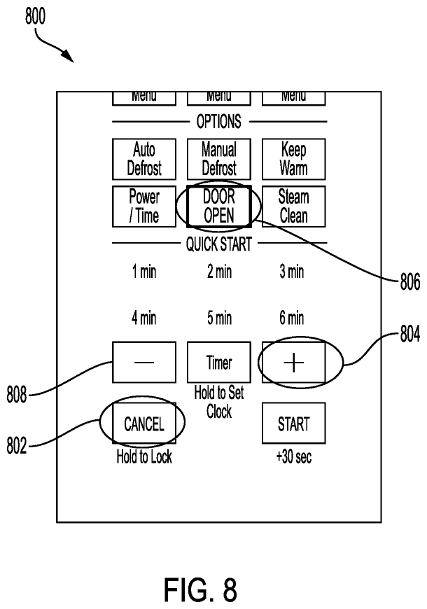

FIG. 8 illustrates an example of entry of a sequence 800 into the control panel 108 to toggle operation of the two-step door opening mechanism 110. Typing the sequence 800 into the control panel 108 may cause the controller 300 to toggle whether the two-step door opening mechanism 110 is enabled. As shown, the sequence 800 may include first pressing a cancel button 802, second pressing the electronic door button 114, and third pressing a plus button 806. It should be noted that this particular sequence 800 is merely an example, and sequences 800 including more, fewer, or different button presses of the control panel 108 may be used. Moreover, in some examples the sequence 800 may include the concurrent pressing of one or more of the buttons of the control panel 108.

Also, in some examples, the sequence to turn on the two-step door opening mechanism 110 may be different from the sequence used to turn off the two-step door opening mechanism 110. For instance, to turn on the two-step door opening mechanism 110, the user may press the cancel button 802, then press the electronic door button 114, then press the plus button 806. However, to turn off the two-step door opening mechanism 110, the user may press the cancel button 802, then press the electronic door button 114, then press a minus button 808.

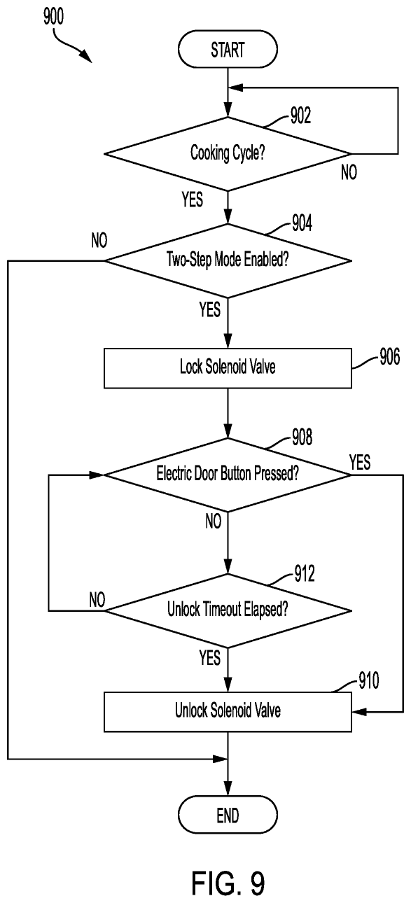

FIG. 9 illustrates an example process 900 for utilizing the two-step door opening mechanism 110 to perform a two-step locking of the door 106 of the oven 100. In an example, the process 900 may be performed by the oven 100 under the operation of the two-step door program 314 executed by the processor 306 of the controller 300. The process 900 may be initiated, for example, responsive to the user selecting from the control panel 108 to perform a cooking cycle.

At operation 902, the controller 300 determines whether a cooking cycle is present. This may include, for instance, the cooking cycle being initiated. If the cooking cycle is initiated, control passes to operation 902. Otherwise, control remains at operation 902.

As a variation, in other examples, operation 902 may transition to operation 904 responsive to completion of the cooking cycle as opposed to initiation. For instance, the controller 300 may identify, via data received from the sensors 310, that the temperature and/or appearance of a food item placed in the oven cavity 104 indicates that the food item is cooked. In another example, the controller 300 may utilize the timer 312 to determine when the cooking cycle is complete, such as due to the expiration of a predefined number of seconds or minutes of operation of the heating elements 308.

At operation 904, the controller 300 determines whether the two-step mode is enabled. In an example, the controller 300 may maintain a bit in the memory 302 indicative of whether the two-step door opening mechanism 110 is enabled or disabled. Accordingly, the controller 300 may access the bit in the memory 302 to determine if the two-step mode is active. If so, control passes to operation 906. If not, then the process 900 ends.

At operation 906, the controller 300 locks the solenoid 202. In an example, the controller 300 may utilize the relay control 204 to place the solenoid 202 into the second, locked state (e.g., by applying power to the solenoid 202). In this state, the shaft 206 of the solenoid 202 may block operation of the door 106. As a result, if a child user attempts to press the mechanical door button 112, the mechanical door button 112 will be unable to move inward to engage the door unlock mechanism (or the door unlock mechanism may otherwise be jammed) and the door 106 to the oven cavity 104 will not be opened.

At operation 908, the controller 300 determines whether the electronic door button 114 was pressed. In an example, the controller 300 may receive signals from the control panel 108 inactive of the status of the buttons or other controls located on the control panel 108. If these signals indicate that the electronic door button 114 was pressed, control passes to operation 910. If not, control passes to operation 912.

At operation 910, the controller 300 unlocks the solenoid 202. In an example, the controller 300 may utilize the relay control 204 to place the solenoid 202 into the first, unlocked state. In this state, the shaft 206 of the solenoid 202 may be moved to allow operation of the mechanical door button 112. As a result, the mechanical door button 112 may again be pressed to engage the door unlock mechanism to open the door 106 to the oven cavity 104. After operation 910, the process 900 ends.

In some examples, the electronic door button 114 may have been pressed after cooking is complete. If, however, the electronic door button 114 was pressed while the cooking cycle is still active, the controller 300 may optionally pause the cooking cycle, similar to what is done if the user presses the pause button during a cooking cycle. This pause action may be performed as it is likely that the user may be about to open the oven cavity 104. In other examples, the cooking cycle (if active) may continue until the user presses the mechanical door button 112.

At operation 912, the controller 300 determines whether an unlock timeout has elapsed. In an example, if no cooking has been performed for a predefined period of time (such as 5 minutes, 20 minutes, 30 minutes, etc.), the controller 300 may determine that the solenoid 202 should be transitioned into the first, unlocked state, regardless of whether the electronic door button 114 was pressed. This determination may be made by the controller 300 using the timer 312, in an example. If the timeout has elapsed, control passes to operation 910. If not, control returns to operation 908.

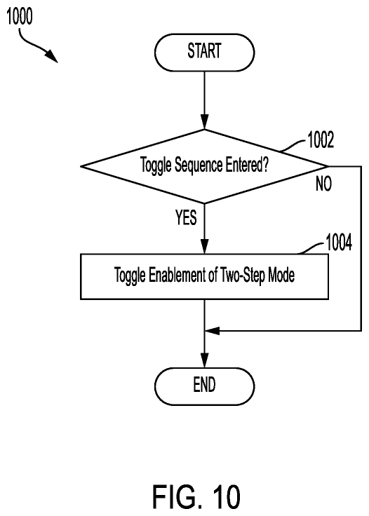

FIG. 10 illustrates an example process 1000 for toggling activation of the two-step locking of the door 106 of the oven 100. In an example, the process 1000 may be performed by the oven 100 under the operation of the two-step door program 314 executed by the processor 306 of the controller 300. The process 1000 may be initiated, for example, responsive to the user providing input to the control panel 108.

At operation 1002, the controller 300 determines whether the toggle sequence 800 was entered. In an example, the controller 300 may maintain a keyboard buffer (in the memory 302 or otherwise) of the most recent keypresses to the control panel 108. If this keyboard buffer includes the sequence 800, then control passes to operation 1004. If not, the process 1000 ends.

At operation 1004, the controller 300 toggles enablement of the two-step mode of the two-step door opening mechanism 110. In an example, as noted in operation 904, the controller 300 may maintain a bit in the memory 302 indicative of whether the two-step door opening mechanism 110 is enabled or disabled. Accordingly, the controller 300 may toggle this bit from the current value to the opposite value. Thus, if the two-step mode was previously enabled, the two-step mode may now be disabled. Similarly, if the two-step mode was previously disabled, the two-step mode may now be enabled. After operation 1004, the process 1000 ends.

Thus, in the two-step mode, child resistance is offered by the two distinct actions of the two-step door opening mechanism 110. Moreover, ease of actuation is maintained by both mechanical door button 112 and the electronic door button 114 being placed on the front face of the oven 100. Yet further, the operation of the two-step mode may be enabled or disabled by a user by entering the sequence 800. Thus, the instant disclosure provides the advantage of having child lock capabilities, as well as providing both buttons 112, 114 as being within easy reach for an adult user on the front face of the oven 100.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A two-step door opening mechanism for an oven, comprising:
a mechanical button and an electronic button, the oven defining an oven cavity openable and closable by an oven door;
a controller; and
a solenoid, comprising a shaft configured to slide laterally between a first, unlocked position in which the shaft allows opening of the oven door and a second, locked position in which the shaft blocks opening of the oven door,
wherein the electronic button, once actuated, directs the controller to direct the solenoid to move the shaft from the second, locked position into the first, unlocked position to unlock the mechanical button, and the mechanical button, once actuated, opens the oven door when the shaft is in the first, unlocked position.

2. The two-step door opening mechanism of claim 1, wherein the controller is configured to direct the solenoid to move the shaft into the second, locked position responsive to initiation of a cooking cycle by the oven.

3. The two-step door opening mechanism of claim 1, wherein the controller is configured to direct the solenoid to move the shaft into the second, locked position responsive to completion of a cooking cycle by the oven.

4. The two-step door opening mechanism of claim 1, wherein the controller is configured to direct the solenoid to move the shaft from the second, locked position into the first, unlocked position responsive to elapsing of a timeout started responsive to initiation or completion of a cooking cycle by the oven.

5. The two-step door opening mechanism of claim 1, wherein the electronic button is located on a control panel of the oven, the control panel being configured to receive user input for selection of cooking cycles.

6. The two-step door opening mechanism of claim 1, wherein the controller is configured to monitor a control panel of the oven for entry of a sequence, such that responsive to entry of the sequence, the controller disables operation of the solenoid to cause the solenoid to remain in the first, unlocked position.

7. The two-step door opening mechanism of claim 6, wherein responsive to entry of the sequence when the solenoid is disabled, the controller reenables operation of the solenoid to cause the solenoid to remain in the first, unlocked position.

8. The two-step door opening mechanism of claim 1, wherein the solenoid is mounted above the mechanical button, such that the shaft is lowered in the second, locked position to block inward movement of the mechanical button, and is raised in the first, unlocked position to allow the inward movement of the mechanical button.

9. The two-step door opening mechanism of claim 1, wherein the oven includes a through hole to receive an instruction configured to move the shaft to allow manual unlocking of the solenoid.

10. The two-step door opening mechanism of claim 1, wherein the shaft in the first, unlocked position allows inward movement of the mechanical button and the shaft in the second, locked position blocks the inward movement of the mechanical button.

11. The two-step door opening mechanism of claim 1, wherein the controller is configured to apply power to the solenoid to place the shaft in the second, locked position, and to remove power from the solenoid to place the shaft in the first, unlocked position.

12. A system for operation of a two-step door opening mechanism for an oven, the two-step door opening mechanism having a mechanical button and an electronic button, the oven defining an oven cavity openable and closable by an oven door, comprising:
a controller configured to
responsive to actuation of the electronic button, direct a solenoid to move a shaft from a second, locked position into a first, unlocked position to unlock the mechanical button; and
responsive to actuation of the mechanical button when unlocked, open a door to an oven cavity.

13. The system of claim 12, wherein the controller is further configured to direct the solenoid to move the shaft into the second, locked position responsive to initiation or completion of a cooking cycle by the oven.

14. The system of claim 12, wherein the controller is further configured to direct the solenoid to move the shaft from the second, locked position into the first, unlocked position responsive to elapsing of a timeout started responsive to initiation or completion of a cooking cycle by the oven.

15. The system of claim 12, wherein the controller is further configured to:
monitor a control panel of the oven for entry of a sequence;
responsive to the entry of the sequence when the solenoid is enabled, disable operation of the solenoid to cause the solenoid to remain in the first, unlocked position; and
responsive to the entry of the sequence when the solenoid is disabled, reenabling operation of the solenoid to cause the solenoid to remain in the first, unlocked position.

16. The system of claim 12, wherein the controller is further configured to:
apply power to the solenoid to place the shaft in the second, locked position; and
remove power from the solenoid to place the shaft in the first, unlocked position.

17. A method for operation of a two-step door opening mechanism for an oven, the two-step door opening mechanism having a mechanical button and an electronic button, the oven defining an oven cavity openable and closable by an oven door, comprising:
responsive to actuation of the electronic button, directing a solenoid to move a shaft from a second, locked position into a first, unlocked position to unlock the mechanical button; and
responsive to actuation of the mechanical button when unlocked, opening a door to an oven cavity.

18. The method of claim 17, further comprising:
directing the solenoid to move the shaft into the second, locked position responsive to initiation or completion of a cooking cycle by the oven; and
directing the solenoid to move the shaft from the second, locked position into the first, unlocked position responsive to elapsing of a timeout started responsive to the initiation or completion of the cooking cycle by the oven.

19. The method of claim 17, further comprising:
monitoring a control panel of the oven for entry of a sequence;
responsive to the entry of the sequence, disabling operation of the solenoid to cause the solenoid to remain in the first, unlocked position; and
responsive to the entry of the sequence when the solenoid is disabled, reenabling operation of the solenoid to cause the solenoid to remain in the first, unlocked position.

20. The method of claim 17, further comprising:
applying power to the solenoid to place the shaft in the second, locked position, and
removing power from the solenoid to place the shaft in the first, unlocked position.
